(19) United States
(12) Patent Application Publication
(10) Pub. No.: US 2021/0090114 A1
(43) Pub. Date: Mar. 25, 2021

(54) INFORMATION PROCESSING DEVICE, INFORMATION PROCESSING SYSTEM, INFORMATION PROCESSING METHOD, AND INFORMATION PROCESSING PROGRAM

(71) Applicant: TOSHIBA TEC KABUSHIKI KAISHA, Tokyo (JP)

(72) Inventor: Keigo Shibata, Tagata Shizuoka (JP)

(21) Appl. No.: 16/898,477

(22) Filed: Jun. 11, 2020

(30) Foreign Application Priority Data
Sep. 24, 2019 (JP) 2019-173504

(51) Int. Cl. G06Q 30/02

(52) U.S. Cl. CPC G06Q 30/0232; G06Q 30/0255; G06Q 30/0224

(57) ABSTRACT

An information processing device according to an embodiment includes a detecting unit and a generating unit. The detecting unit detects a store visit of a customer to a store. The generating unit determines, if the store visit of the customer to the store is detected, based on purchase history information of the customer in the store, a target commodity of privilege information distributed to the customer out of a plurality of commodities, sell-by dates of which are set to points in time within a predetermined time from a point in time of the store visit, in the store and generates the privilege information concerning the target commodity distributed to the customer.

### CROSS-REFERENCE TO RELATED APPLICATION

This application is based upon and claims the benefit of priority from. Japanese Patent Application No. 2019-173504, filed in Sep. 24, 2019, the entire contents of which are incorporated herein by reference.

### FIELD

Embodiments described herein relate generally to an information processing device, an information processing system, an information processing method, and an information processing program.

### BACKGROUND

As one of measures for preventing food loss, a service for selling commodities at a discount, sell-by dates of which is close, has been performed. The food loss means that foods (commodities) that can be still eaten are discarded because of, for example, sell-by dates. As a method of selling commodities at a discount, there has been known a method of distributing a coupon (privilege information) concerning a discount target commodity.

However, discount targeting an unspecified large number of customers cannot secure a profit of a store if timing of the discount is early or if there are customers who purchase only discounted commodities. On the other hand, even discount targeting specific customers cannot reduce food loss if timing of the discount is late or if discounted commodities do not match customers visiting the store.

Related art is described in, for example, JP-A-2009-230485.

### DESCRIPTION OF THE DRAWINGS

FIG. 1 is a diagram illustrating an example of the configuration of a coupon distribution system according to an embodiment;

FIG. 2 is a diagram illustrating an example of the configuration of a server illustrated in FIG. 1;

FIG. 3 is a diagram illustrating an example of functions of the server;

FIG. 4 is a diagram for explaining information retained by units of the server;

FIG. 5 is a diagram illustrating an example of the configuration of a terminal illustrated in FIG. 1;

FIG. 6 is a diagram illustrating an example of functions of the terminal;

FIG. 7 is a flowchart illustrating an example of client processing of a coupon distribution service executed by the terminal; and

FIG. 8 is a flowchart illustrating an example of server processing of the coupon distribution service executed by the server.

### DETAILED DESCRIPTION

An object of embodiments is to provide an information processing device, an information processing system, an information processing method, and an information processing program that can generate different privilege information for each of customers visiting a store.

An information processing device according to an embodiment includes a detecting unit and a generating unit. The detecting unit detects a store visit of a customer to a store. The generating unit determines, if the store visit of the customer to the store is detected, based on purchase history information of the customer in the store, a target commodity of privilege information distributed to the customer out of a plurality of commodities, sell-by dates of which are set to points in time within a predetermined time from a point in time of the store visit, in the store and generates the privilege information concerning the target commodity distributed to the customer.

An information processing device, an information processing system, an information processing method, and an information processing program according to an embodiment are explained below with reference to the accompanying drawings.

In this embodiment, a coupon distribution system, which is an example of the information processing system, is explained. The coupon distribution system is a system that provides privilege information (a coupon) concerning a commodity to a customer visiting a store. The coupon distribution system is a system that determines, based on a purchase history of a customer, a target commodity of the privilege information (the coupon) out of a plurality of commodities, sell-by dates of which are close to a store visit time of the customer.

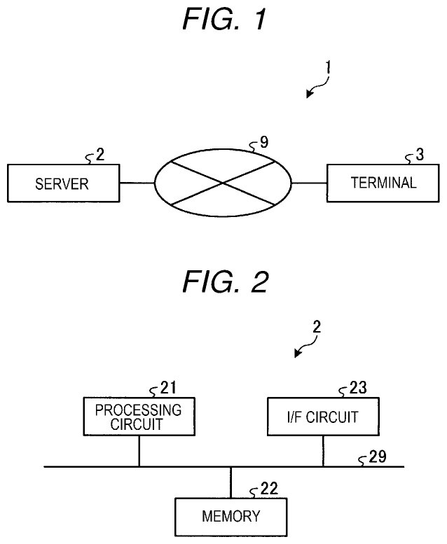

FIG. 1 is a diagram illustrating an example of the configuration of a coupon distribution system 1 according to the embodiment. As illustrated in FIG. 1, the coupon distribution system 1 is a server-client system including a server 2 and a terminal 3. The server 2 and the terminal 3 are communicably connected to each other via a network 9. As the network 9, an electric communication line such as the Internet or an intranet can be used.

FIG. 2 is a diagram illustrating an example of the configuration of the server 2 illustrated in FIG. 1. As illustrated in FIG. 2, the server 2 includes a processing circuit 21, a memory 22, and an I/F circuit 23. The processing circuit 21, the memory 22, and the I/F circuit 23 are communicably connected to one another via a bus 29 or the like. The server 2 is connected to the network 9 via the I/F circuit 23. The server 2 may be connected to the network 9 by wire or may be connected to the network 9 by radio. As wireless communication, Wi-Fi (registered trademark), Bluetooth (registered trademark), and the like can be used as appropriate. The server 2 is an example of the information processing device.

The processing circuit 21 controls the operation of the entire server 2. As the processing circuit 21, for example, a CPU (Central Processing Unit) can be used. However, other processors such as a GPU (Graphics Processing Unit), an ASIC (Application Specific Integrated Circuit), and an FPGA (Field Programmable Gate Array) may be used.

The memory 22 stores various data and programs used in the server 2. The data stored in the memory 22 includes member information, a purchase history of each of customers, and commodity information of the store explained below. The programs stored in the memory 22 include a coupon distribution program explained below. As the memory 22, various storage media such as a HDD (Hard Disk Drive), an SSD (Solid State Drive), and a Flash memory can be used. In the memory 22, a RAM (Random Access Memory) that temporarily stores data under operation is further provided.

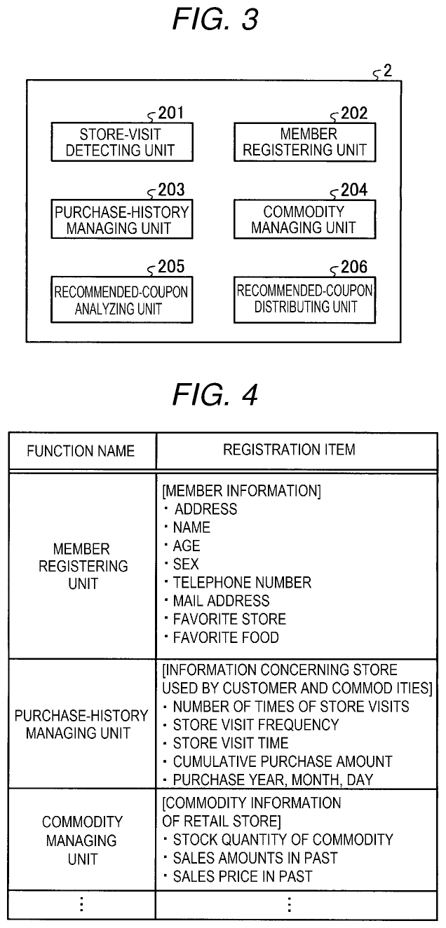

FIG. 3 is a diagram illustrating an example of functions of the server 2 illustrated in FIG. 1. FIG. 4 is a diagram for explaining information retained by the units of the server 2 illustrated in FIG. 1. The processing circuit 21 executes, for example, the coupon distribution program loaded on the memory 22, whereby the server 2 realizes functions of a store-visit detecting unit 201, a member registering unit 202, a purchase-history managing unit 203, a commodity managing unit 204, a recommended-coupon analyzing unit 205, and a recommended-coupon distributing unit 206.

The store-visit detecting unit 201 refers to the member registering unit 202 based on a store-visit notification received from the terminal 3 and specifies a customer visiting the store. The store-visit detecting unit 201 is an example of a detecting unit.

The member registering unit 202 receives registration of member information of the customer from the terminal 3. As the member information, “address”, “name”, “age”, “sex”, “telephone number”, “mail address”, “favorite store”, “favorite commodity”, and the like of the customer are registered. It is assumed that member registration is essential if the customer uses the coupon distribution service. The registered member information is recorded in a member list.

The purchase-history managing unit 203 manages, for each store, purchase history information concerning customers registered as members. It is assumed that, as the purchase history information, “number of times of store visits”, “store visit frequency”, “store visit time”, “cumulative purchase amount”, “purchase year, month, day”, and the like are registered.

The commodity managing unit 204 manages a store list and commodity information of stores in the store list. It is assumed that, as the commodity information, “stock quantities of commodities”, “sell-by dates of commodities”, “sales results in the past”, and the like of the stores are registered.

The recommended-coupon analyzing unit 205 determines, based on the purchase history information and the commodity information, a target commodity for which a coupon is issued according to a customer visiting the store. The recommended-coupon analyzing unit 205 is an example of a generating unit.

The recommended-coupon distributing unit 206 issues the coupon determined by the recommended-coupon analyzing unit 205 and distributes the coupon to the terminal 3 of the customer. The recommended-coupon distributing unit 206 is an example of a distributing unit.

The store-visit detecting unit 201, the member registering unit 202, the purchase-history managing unit 203, the commodity managing unit 204, the recommended-coupon analyzing unit 205, and the recommended-coupon distributing unit 206 may be executed by two or more servers.

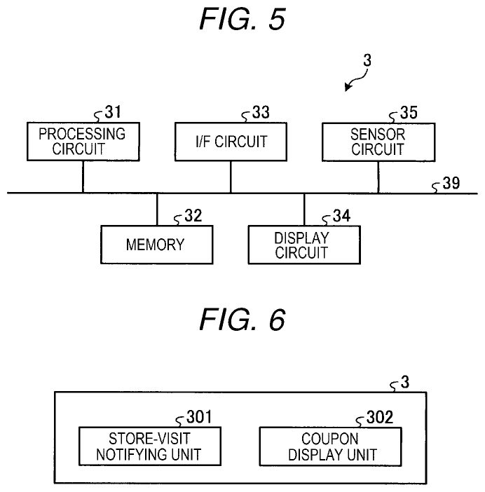

As the terminal 3, various information communication terminals configured to be capable of executing at least a display function and a communication function such as a smartphone, a tablet PC, and a smartwatch can be used as appropriate. FIG. 5 is a diagram illustrating an example of the configuration of the terminal 3 illustrated in FIG. 1. As illustrated in FIG. 5, the terminal 3 includes a processing circuit 31, a memory 32, an I/F circuit 33, a display circuit 34, and a sensor circuit 35. The processing circuit 31, the memory 32, the I/F circuit 33, the display circuit 34, and the sensor circuit 35 are communicably connected to one another via a bus 39. The terminal 3 is connected to the network 9 via the I/F circuit 33. The terminal 3 may be connected to the network 9 by wire or may be connected to the network 9 by radio. As wireless communication, 3G and 4G communication, Wi-Fi (registered trademark) communication, Bluetooth (registered trademark) communication, and the like can be used as appropriate. In the following explanation, it is assumed that the terminal 3 is connected to the network 9 by wireless communication.

The processing circuit 31 controls the operation of the entire terminal 3. As the processing circuit 31, for example, a CPU (Central Processing Unit) can be used. However, other processors such as a GPU (Graphics Processing Unit), an ASIC (Application Specific Integrated Circuit), and an FPGA (Field Programmable Gate Array) may be used.

The memory 32 stores various data and programs used in the terminal 3. The data stored in the memory 32 includes a coupon application explained below. As the memory 32, various storage media such as a HDD (Hard Disk Drive), an SSD (Solid State Drive), and a Flash memory can be used. In the memory 32, a RAM (Random Access Memory) that temporarily stores data under operation is further provided.

The I/F circuit 33 includes an input circuit and a communication circuit. The input circuit is a circuit that receives an input of a user. For example, a touch panel or a keyboard can be use as the input circuit. The communication circuit is a circuit for connection to the network 9. The communication circuit includes circuits for wireless communication such as 3G and 4G communication, Wi-Fi communication, and Bluetooth communication.

The display circuit 34 is a circuit that displays various image data such as a coupon. A liquid crystal display, an organic EL display, and the like can be used as the display circuit 34.

The sensor circuit 35 is a circuit that acquires position information based on a positioning system such as a GPS (Global Positioning System).

FIG. 6 is a diagram illustrating an example of functions of the terminal 3 illustrated in FIG. 1. For example, the processing circuit 31 executes a coupon use program loaded on the memory 32, whereby the terminal 3 realizes an application for portable terminal (hereinafter referred to as coupon application). The coupon application has functions of a store-visit notifying unit 301 and a coupon display unit 302.

After the application is started, the store-visit notifying unit 301 transmits a store visit notification to the server 2. The store visit notification includes information for specifying a customer and position information. As the information for specifying a customer, a customer ID issued to each of customers may be used or a part of member information such as a mail address may be used. In the following explanation, it is assumed that a customer ID is set during member registration and the customer ID is included in the store visit notification. The store-visit notifying unit 301 is an example of a notifying unit.

The coupon display unit 302 displays a coupon received from the server 2. An image of the coupon to be displayed may be generated by the server 2 or may be generated by the terminal 3 based on information received from the server 2. The image of the coupon to be displayed includes information indicating a discount target commodity and information indicating discount content. As the information indicating the discount target commodity, a name of the commodity may be used, a photograph of the commodity may be used, or an icon such as an illustration of the commodity may be used. The information indicating the discount target commodity may include a sell-by date such as an expiration date or a best before date. The information indicating the discount content may be a discount amount, may be a discount rate, or may be a price after discount. The coupon display unit 302 is an example of a display unit.

Problems that occur in the developed countries such as Japan include food loss. The food loss means that foods (commodities) that can be still eaten are discarded because of, for example, sell-by dates. Commodities displayed in a store are purchased (boxed lunches and daily dishes are cooked) based on a schedule and data and sold. However, commodities more than expected sometimes remain unsold because of a change of weather or a simple prediction mistake. In such a case, a situation in which the commodities have to be discarded, that is, food loss occurs.

As one of measures for preventing food loss, a service for selling commodities at a discount, sell-by dates of which close, has been performed. For example, if sell-by dates approach, commodities such as boxed lunches and daily dishes are sometimes sold at a discount in order to prevent the commodities from being discarded because the commodities remain unsold. As a method of selling commodities at a discount, for example, there is a method of pasting discount stickers to discount target commodities.

However, if timing for pasting the discount stickers is late, the commodities are less likely to be purchased even if the commodities are discounted because fewer customers are present in a store. On the other hand, if the timing for pasting the discount stickers is early, profit of the store decreases because more foods are sold at a discount.

In the method of pasting the discount stickers, discount is not notified by a flyer, an application, or the like unlike, for example, time sale. Therefore, customers cannot confirm the discount unless the customers directly see displayed commodities. Further, profit of the store decreases because of customers who choose timing when the discount stickers are pasted, that is, customers who do not purchase commodities at normal prices.

As another method of selling commodities at a discount, there has been known a method of distributing a coupon (privilege information) concerning a discount target commodity. As the coupon, there are a coupon of a paper medium and a coupon of an electronic medium that can be acquired on the Internet. However, in discount targeting an unspecified large number of customers, if customers visiting a store and discounted commodities do not match, the commodities are less likely to be purchased even if the commodities are discounted.

Therefore, in this embodiment, a service for distributing, based on purchase information of each of customers, different coupons concerning commodities, sell-by dates of which are close, to each of the customers (hereinafter coupon distribution service) is provided. More specifically, based on “store use frequencies” and “purchase amounts in the past” of customers, “a coupon of a commodity, a sell-by data of which is close” different depending on a customer is provided when the customer visits a store. Consequently, the store can realize a commodity loss reduction and maintenance of sales profit. At the same time, the customer can purchase a desired commodity at a price lower than usual because the customer can obtain a coupon of a commodity that the customer is highly likely to purchase, that is, a commodity attractive for the customer.

Server-client processing in the coupon distribution service according to the embodiment is explained below with reference to the drawings. Server processing is processing on a store side executed by the server 2. Client processing is processing on a user side executed by the terminal 3.

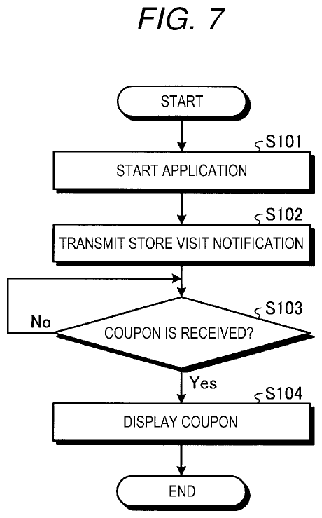

FIG. 7 is a flowchart illustrating an example of the client processing of the coupon distribution service executed by the terminal 3 illustrated in FIG. 1. The processing explained below is processing started, for example, when a user (a customer) arrives at a store.

It is assumed that the user (the customer) downloads and installs the coupon application according to the embodiment in the terminal 3, the user finishes member registration before visiting the store, and the user is carrying the terminal 3 installed with the coupon application when visiting the store.

The terminal 3 receives, for example, via the I/F circuit 33, operation by the user arriving at the store and starts the coupon application (Act 101). After the coupon application is started, the store-visit notifying unit 301 transmits (notifies) a store visit notification to the server 2 (Act 102). Specifically, the store-visit notifying unit 301 generates position information based on a positioning result of a GPS and transmits the generated position information to the server 2. The store-visit notifying unit 301 transmits a customer ID set in advance and stored in the memory 32 to the server 2.

In this way, the customer starts the application after arriving at the store to notify the position information and the customer ID to the store. Consequently, the server 2, which is a system on the store side, recognizes (detects) a store visit of the customer and generates a coupon corresponding to purchase history information of the customer and commodity information of the store.

After Act 102, the coupon display unit 302 determines whether the coupon is received from the server 2 (Act 103). A flow of FIG. 7 proceeds to Act 104 if it is determined that the coupon is received (Yes in Act 103). The flow of FIG. 7 may be a flow proceeding to Act 104 if the coupon transmitted from the server 2 is simply received. That is, determination processing does not always need to be executed in Act 103. After Act 103, the coupon display unit 302 displays the received coupon. The user views the displayed coupon and purchases a target product of the coupon. The user can receive discount corresponding to the coupon by showing a display screen of the coupon to a store clerk. Naturally, content of the coupon may be notified to the store side and referred to by a POS. Thereafter, the terminal 3 receives operation by the user, for example, via the I/F circuit 33 and ends the coupon application.

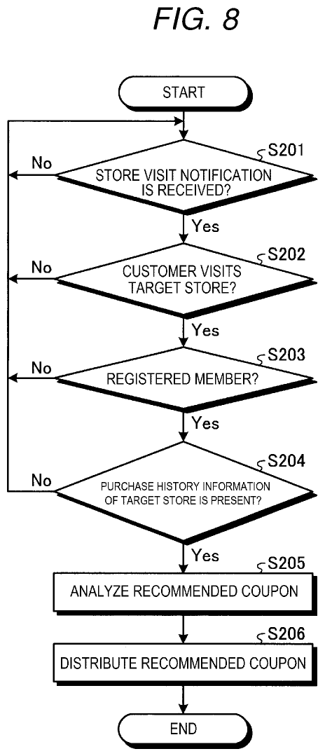

FIG. 8 is a flowchart illustrating an example of the server processing of the coupon distribution service executed by the server 2 illustrate in FIG. 1.

The store-visit detecting unit 201 determines whether a store visit notification including a customer ID and position information is received (Act 201). A flow of FIG. 8 stays on standby if the store visit notification is not received (No in Act 201) and proceeds to Act 202 if the store visit notification is received (Yes in Act 201).

The store-visit detecting unit 201 inputs the received position information to the commodity managing unit 204. The commodity managing unit 204 receives the position information, searches for a target store coinciding with the position information referring to a store list, and outputs a search result. The store-visit detecting unit 201 acquires the search result and determines presence or absence of the target store coinciding with the position information (Act 202). If the target store coinciding with the position information of the received store visit notification is absent (No in Act 202), it is determined that the store is not the target store of the coupon distribution service or the customer is not visiting the target store. The flow of FIG. 8 returns to Act 201 and stays on standby until the store visit notification is received. On the other hand, if the target store coinciding with the position information of the received store visit notification is present (Yes in Act 202), it is determined that the customer visits the target store and the flow of FIG. 8 proceeds to Act 203.

The store-visit detecting unit 201 inputs the received customer ID to the member registering unit 202. The member registering unit 202 receives the customer ID, searches for member information coinciding with the customer ID referring to a member list, and outputs a search result. The store-visit detecting unit 201 acquires the search result and determines whether the member information coinciding with the received customer ID is present (Act 203). If the member information coinciding with the received customer ID is absent (No in Act 203), it is determined that the customer is not a registered member and the flow of FIG. 8 returns to Act 201. If the member information coinciding with the received customer ID is absent (No in Act 203), a notification for urging member registration may be transmitted to the terminal 3. On the other hand, if the member information coinciding with the received customer ID is present (Yes in Act 203), it is determined that the customer is a registered member and the flow of FIG. 8 proceeds to Act 204.

The store-visit detecting unit 201 inputs the customer ID and information for specifying the target store (hereinafter referred to as store ID) to the purchase-history managing unit 203. The purchase-history managing unit 203 receives the customer ID and the store ID, searches for purchase history information of the registered member in the target store, and outputs a search result. The store-visit detecting unit 201 acquires the search result and determines whether the purchase history information of the registered member in the target store is present (Act 204). The flow of FIG. 8 proceeds to Act 205 if the purchase history information of the registered member in the target store is present and returns to Act 201 if the purchase history information of the registered member in the target store is absent.

The store-visit detecting unit 201 inputs the customer ID and the store ID to the recommended-coupon analyzing unit 205. The recommended-coupon analyzing unit 205 analyzes a recommended coupon for the registered member visiting the target store (Act 205). Specifically, the recommended-coupon analyzing unit 205 acquires, based on the customer ID and the store ID, the purchase history information of the registered member in the target store from the purchase-history managing unit 203 and acquires, from the commodity managing unit 204, information concerning a plurality of commodities, sell-by dates of which are close, in the target store where the registered member visits. Thereafter, the recommended-coupon analyzing unit 205 determines, based on the purchase history information, as a target commodity of a coupon, a commodity highly likely to be purchased by the customer when the coupon is distributed among the plurality of commodities, the sell-by dates of which are close, in the target store.

It is assumed that the commodity, the sell-by date of which is close, is a commodity, a sell-by date of which is set at a point in time within a predetermined time from a point in time when the customer visits the store. As the predetermined time, for example, a time until business in the day of the target store ends. As the sell-by date, expiration dates and best before dates of commodities can be used. However, a date set according to a sales target of the store may be used. The predetermined time may be determined for each of commodities according to types and states of the commodities.

The recommended-coupon analyzing unit 205 may predict a commodity likely to remain unsold among the plurality of commodities, the sell-by dates of which are close, and preferentially determine the predicted commodity as the target commodity of the coupon. For example, the recommended-coupon analyzing unit 205 acquires stock quantities of the plurality of commodities, the sell-by dates of which are close, from the commodity managing unit 204 and predicts a commodity with a large stock quantity as the commodity likely to remain unsold. For example, the recommended-coupon analyzing unit 205 acquires histories of the stock quantities of the plurality of commodities, the sell-by dates of which are close, from the commodity managing unit 204 and predicts a commodity with a small decrease in the stock quantity as the commodity likely to remain unsold. For example, the recommended-coupon analyzing unit 205 predicts the commodity likely to remain unsold based on a sales result or the like in the past in each time period. For example, the recommended-coupon analyzing unit 205 predicts a commodity with a flag indicating an order mistake as the commodity likely to remain unsold.

The target commodity of the coupon determined from the commodities, the sell-by dates of which are close, is determined when the customer visits the store. Therefore, the target commodity of the coupon is determined from, for example, a plurality of commodities displayed in a storefront when the customer visits the store. However, the target commodity of the coupon is not limited to this. The target commodity of the coupon does not always have to be displayed in the storefront when the customer visits the store. A commodity not displayed in the storefront, for example, from the viewpoint of a sales space although a sell-by date does not expire could be present. In this case, information indicating that the target commodity is absent in the storefront may be further added to the display screen of the coupon to be distributed. The customer is capable of purchasing the target commodity by presenting the display screen of the coupon to a store clerk.

Examples of the commodity highly likely to be purchased by the customer when the coupon is distributed include a commodity registered as a favorite commodity (food) during member registration, a commodity purchased recently, a commodity purchased in the past actually using the coupon, a commodity with a high purchase frequency, a commodity purchased in the same time period as a store visit time of this time, and commodities similar to these commodities.

The recommended-coupon analyzing unit 205 determines content of the coupon concerning the target commodity.

For example, the recommended-coupon analyzing unit 205 acquires information concerning a discount price and a time period of discount application in the past from the commodity managing unit 204 and determines content of the coupon such that the target commodity can be purchased at a lower price than when the discount sticker is pasted. At this time, the coupon distribution service according to this embodiment may be implemented together with the discount by the discount sticker. That is, the content of the coupon may be determined, irrespective of the discount price and the time period of the discount application in the past, based on a present discount price by the discount sticker and whether the discount by the discount sticker is currently performed.

For example, the recommended-coupon analyzing unit 205 determines, based on the purchase history information acquired from the purchase-history managing unit 203, that the coupon is more preferentially distributed as a purchase amount and a value of the number of times of store visits in the past are larger.

Preferentially distributing the coupon is not limited to simply setting priority of distribution of the coupon high and includes setting priority of content of the coupon high. For example, the recommended-coupon analyzing unit 205 may determine content of a more valuable coupon as the purchase amount and the value of the number of times of store visits in the past are larger. The valuable coupon can include a coupon applied to a large number of target commodities and a coupon concerning a plurality of target commodities irrespective of whether a discount amount is simply large. As the purchase amount in the past, a cumulative amount of purchase amounts in the past may be simply used or a cumulative amount excluding purchase amounts in the case of use of the coupon may be used. If the cumulative amount excluding the purchase amounts in the case of use of the coupon is used, coupon distribution to customers intending to purchase only discounted commodities is suppressed. A profit decrease on the store side can be suppressed.

Thereafter, the recommended-coupon distributing unit 206 distributes the coupon including the determined content to the terminal 3 carried by the registered member.

The determination about whether the store is the target store in Act 202 may be performed according to presence or absence of a plurality of commodities, sell-by dates of which are close.

A plurality of same commodities displayed in the store sometimes have a plurality of sell-by dates. If a commodity, a sell-by date of which is close, is set as the target commodity of the coupon in such a situation, in order to present to the customer which commodity is the target commodity of the coupon, a sell-by date (an expiration date or a best before date) could be included in the display screen of the coupon as information for specifying the target commodity. A sticker or the like indicating the target commodity may be pasted to the target commodity of the coupon. With these configurations, the customer can distinguish the target commodity of the coupon. Since the discount is enabled by the distribution of the coupon, the store can paste the sticker indicating the target product without worrying about timing unlike the discount sticker. A profit decrease on the store side due to customers intending to purchase only discounted commodities can be suppressed.

The customer arriving at the store may be detected by causing the terminal 3 to display a display screen including a code symbol such as a QR code (registered trademark) or a barcode and the customer causing a scanner or the like prepared in the store to read the display screen.

In specifications for connection to Wi-Fi or the like during an application start, the customer arriving at the store may be detected based on position information of an access point prepared in the store.

The customer arriving at the store may be detected by analyzing an image obtained by a camera prepared in the store.

In this way, if detecting the store visit of the customer to the store, the coupon distribution system 1 according to this embodiment determines, based on the purchase history information of the customer in the store, the target commodity of the coupon (the privilege information) of the customer among the plurality of commodities, the sell-by dates of which are set within the predetermined time from the store visit point in time. The coupon distribution system 1 generates the coupon of the determined commodity and provides the coupon to the customer. Consequently, it is possible to provide the coupon reflecting the purchase history of the customer to each of customers. Therefore, the customer can purchase the commodity at a lower price than normal discount. With such a coupon, buying intention to “a commodity predicted to be discarded” of the customer can be facilitated. Therefore, the store can also expect an increase in sales and a reduction of food disposal (food loss).

The coupon distribution system 1 according to this embodiment does not simply “distribute a coupon of a commodity, a sell-by date of which is close, to an unspecified large number of customers” and “distributes a coupon preferentially for a commodity particularly likely to remain unsold among commodities, sell-by dates of which are close” “targeting customers having larger purchase amounts and numbers of store visits in the past”. With this configuration, compared with when the discount sales is performed by the discount sticker, “bias in commodities remaining unsold” and “an increase of people waiting until the discount sticker is pasted (a decrease of people purchasing at a normal price)” can be suppressed. Therefore, a profit decrease on the store side can be suppressed.

According to the at least one embodiment explained above, it is possible to provide an information processing device, an information processing system, an information processing method, and an information processing program that can generate different privilege information for each of customers visiting a store.

The information processing device and the terminal in this embodiment may have a hardware configuration including a control device such as a CPU, a storage device such as a ROM (Read Only Memory) or a RAM, an external storage device such as a HDD or a CD drive device, a display device such as a display, and an input device such as a keyboard or a mouse and using a normal computer.

The programs executed by the information processing device and the terminal in this embodiment may be provided while being recorded in a computer-readable recording medium such as a CD-ROM, a flexible disk (FD), a CD-R, or a DVD (Digital Versatile Disk) as a file of an installable format or an executable format.

The programs executed by the information processing device and the terminal in this embodiment may be stored on a computer connected to a network such as the Internet and provided by being downloaded through the network. The programs executed by the information processing device and the terminal in this embodiment may be provided or distributed through a network such as the Internet.

The programs executed by the information processing device and the terminal in this embodiment may be incorporated in a ROM or the like and provided.

The coupon distribution program executed by the information processing device in this embodiment has a module configuration including the units explained above (the store-visit detecting unit 201, the member registering unit 202, the purchase-history managing unit 203, the commodity managing unit 204, the recommended-coupon analyzing unit 205, and the recommended-coupon distributing unit 206). A CPU (a processor) reads out the coupon distribution program from the storage medium and loads the units on a main storage device. Consequently, the store-visit detecting unit 201, the member registering unit 202, the purchase-history managing unit 203, the commodity managing unit 204, the recommended-coupon analyzing unit 205, and the recommended-coupon distributing unit 206 are generated on the main storage device.

The coupon use program executed by the information processing device in this embodiment has a module configuration including the units explained above (the store-visit notifying unit 301 and the coupon display unit 302). A CPU (a processor) reads out the coupon use program from the storage medium and loads the units on a main storage device. Consequently, the store-visit notifying unit 301 and the coupon display unit 302 are generated on the main storage device.

The several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. An information processing device, comprising:
a detector configured to detect a store visit of a customer to a store; and
a generating component configured to determine, if the store visit of the customer to the store is detected, based on purchase history information of the customer in the store, a target commodity of privilege information distributed to the customer out of a plurality of commodities, sell-by dates of which are set to points in time within a predetermined time from a point in time of the store visit, in the store and generate the privilege information concerning the target commodity distributed to the customer.

2. The device according to claim 1, wherein the purchase history information includes at least one of a number of times of store visits, a store visit frequency, a store visit time, a cumulative purchase amount, and purchase year, month, and day of the customer in the store.

3. The device according to claim 1, wherein the generating component determines that the privilege information is more preferentially distributed as a store use frequency or a purchase amount in past of the customer in the store is larger.

4. The device according to claim 1, wherein the privilege information includes information indicating the target commodity and information indicating a sell-by date of the target commodity.

5. An information processing system, comprising:
the information processing device according to claim 1; and
a terminal including a notifying component configured to receive operation by the customer and transmit a store visit notification for notifying that the customer visits the store and a display configured to display the received privilege information, wherein
the information processing device further includes a distributing component configured to distribute the privilege information to the terminal, and
the detector receives the store visit notification and detects the store visit of the customer to the store based on the store visit notification.

6. The system according to claim 5, wherein the store visit notification includes information for specifying the customer and position information of the customer.

7. The device according to claim 1, wherein the generating component comprises a recommended-coupon analyzing component that determines, based on the purchase history information and the commodity information, a target commodity for which a coupon is issued according to a customer visiting the store.

8. The device according to claim 1, wherein the target commodity is a perishable food commodity.

9. The device according to claim 4, wherein the sell-by date of the target commodity is an expiration date or a best-before date.

10. An information processing method, comprising:
receiving a store visit notification for notifying that a customer visits a store;
detecting a store visit of the customer to the store based on the store visit notification;
determining, if the store visit of the customer to the store is detected, based on purchase history information of the customer in the store, a target commodity of privilege information distributed to the customer out of a plurality of commodities, sell-by dates of which are set to points in time within a predetermined time from a point in time of the store visit, in the store; and
generating the privilege information concerning the target commodity distributed to the customer.

11. The method according to claim 10, wherein the purchase history information includes at least one of a number of times of store visits, a store visit frequency, a store visit time, a cumulative purchase amount, and purchase year, month, and day of the customer in the store.

12. The method according to claim 10, further comprising:
determining that the privilege information is more preferentially distributed as a store use frequency or a purchase amount in past of the customer in the store is larger.

13. The method according to claim 10, wherein the privilege information includes information indicating the target commodity and information indicating a sell-by date of the target commodity.

14. The method according to claim 10, further comprising:
receiving operation by the customer and transmitting a store visit notification for notifying that the customer visits the store and a display configured to display the received privilege information;
distributing the privilege information to a terminal of the customer; and
receiving the store visit notification and detecting the store visit of the customer to the store based on the store visit notification.

15. The method according to claim 14, wherein the store visit notification includes information for specifying the customer and position information of the customer.

16. The method according to claim 10, further comprising:
determining, based on the purchase history information and the commodity information, a target commodity for which a coupon is issued according to a customer visiting the store.

17. The method according to claim 10, wherein the target commodity is a perishable food commodity.

18. Anon-transitory computer readable storage medium having program instructions embodied therewith, the program instructions executable by a processing component to cause the processing component to:
receive a store visit notification for notifying that a customer visits a store;
detect a store visit of the customer to the store based on the store visit notification;
determine, if the store visit of the customer to the store is detected, based on purchase history information of the customer in the store, a target commodity of privilege information distributed to the customer out of a plurality of commodities, sell-by dates of which are set to points in time within a predetermined time from a point in time of the store visit, in the store; and
generate the privilege information concerning the target commodity distributed to the customer.

19. The non-transitory computer readable storage medium according to claim 18, wherein the purchase history information includes at least one of a number of times of store visits, a store visit frequency, a store visit time, a cumulative purchase amount, and purchase year, month, and day of the customer in the store.

20. The non-transitory computer readable storage medium according to claim 19, the program instructions executable by a processing component to further cause the processing component to:
determine that the privilege information is more preferentially distributed as a store use frequency or a purchase amount in past of the customer in the store is larger.
